(19) United States
(12) Patent Application Publication
(10) Pub. No.: US 2012/0016857 A1
(43) Pub. Date: Jan. 19, 2012

(54) SYSTEM AND METHOD FOR PROVIDING SEARCH ENGINE OPTIMIZATION ANALYSIS

(76) Inventors: Levi Gross, Los Angeles, CA (US); Aryeh Leib Schottenstein, Los Angeles, CA (US)

(21) Appl. No.: 12/838,234

(22) Filed: Jul. 16, 2010

(51) Int. Cl. G06F 17/30

(52) U.S. Cl. 707/706; 707/E17.108

(57) ABSTRACT

A system and method for providing search engine optimization analysis. A starting URL for a starting web resource is obtained and analyzed. A text-based portion of the starting web resource is processed to determine potential target terms, and a relevancy test is performed based on the potential target terms. Referred URLs are determined and recursively analyzed. A text-based portion of the referred web resource is processed to determine potential target terms, and a relevancy test is performed based on the potential target terms. A link index is analyzed to determine web resources linking to the starting and referred URLs. An internal search engine optimization score and an external search engine optimization score are calculated. A graphical report including a visualization of statistical information related to search engine optimization and a domain visualization map including a graphical network representation of the statistical information are provided.

### BACKGROUND OF THE INVENTION

1. Field of the Invention

Embodiments of the invention described herein pertain to the field of computer systems. More particularly, but not by way of limitation, one or more embodiments of the invention enable systems and methods for providing search engine optimization analysis.

2. Description of the Related Art

The Internet is a growing medium for commercial interaction and marketing. Search engines are a valuable resource for generating web traffic. Search engine providers, such as Google™, Yahoo!™, Microsoft Bing™, generate search results in response to a query that includes search terms. Organic search results include an ordered list of web resources based on their relevance to the search terms, as calculated by the search engine provider. Search engine providers often maintain a proprietary index of the Internet in order to quickly generate search results using proprietary algorithms.

Search engine optimization refers to the process of increasing web traffic directed from search engine providers. Search engine optimization also refers to improving the quality of web traffic directed from search engine providers, such as by improving the relevance of web resources to search terms entered by a user that is directed to the web resource by the search engine provider. Although search engine providers discourage the use of harmful techniques to improve the ranking of web resources that are not relevant to the search terms, search engine providers recognize that there are legitimate methods for search engine optimization which improve the relevance of web resources to specific search terms.

Search engine optimization tools are offered by various organizations. However, the search engine optimization analysis generated by these organizations are typically limited. For example, these providers do not offer the ability to export complete information, the ability to generate dynamic search engine optimization analysis in response to modifications, the ability to access complete analysis, and the ability to view all data analysis in a meaningful manner.

To overcome the problems and limitations described above there is a need for a system and method for providing search engine optimization analysis.

### BRIEF SUMMARY OF THE INVENTION

One or more embodiments of the invention enable a computer-readable medium encoded with computer-readable instructions for providing search engine optimization analysis. Execution of the computer-readable instructions by one or more processors causes the one or more processors to carry out steps which include obtaining a starting uniform resource locator (URL) that identifies a network location for a starting web resource.

The steps of the computer-readable medium encoded with computer-readable instructions for providing search engine optimization analysis further include analyzing a starting web resource associated with the starting URL. The analysis includes obtaining a text-based portion of the starting web resource. The text-based portion of the starting web resource includes data and metadata. The data and the metadata are processed to determine a plurality of potential target terms. A relevancy test is performed on the text-based portion of the starting web resource based on the potential target terms.

In one or more embodiments, the text-based portion of the starting web resource includes hypertext markup language (HTML) and/or extensible markup language (XML). Processing the data and metadata may include using at least one value to determine relevancy of text of at least one of a title tag, a H1 tag, a H2 tag, a H3 tag, an HTTP header, a URL, an image file name, an image alt tag, a microformat, and a metatag. In one or more embodiments, the computer-readable instructions further include allowing a user to dynamically modify one or more of the at least one weight value.

The steps of the computer-readable medium encoded with computer-readable instructions for providing search engine optimization analysis further include determining any referred URLs in the text-based portion of the starting web resource. The referred URLs each identify a referred web resource sharing a domain with the starting web resource.

The steps of the computer-readable medium encoded with computer-readable instructions for providing search engine optimization analysis further include recursively analyzing the referred URLs. The recursive analysis includes obtaining a text-based portion of a referred web resource, processing data and metadata in the text-based portion of the referred web resource to determine potential target terms for each referred web resource, and performing a relevancy test of the text-based portion of each referred web resource based on the potential target terms for each referred web resource.

The steps of the computer-readable medium encoded with computer-readable instructions for providing search engine optimization analysis further include analyzing a link index of a network. The link index includes the starting URL. The analysis of the link index includes determining web resources linking to the web resources associated with the starting URL and the referred URLs.

The steps of the computer-readable medium encoded with computer-readable instructions for providing search engine optimization analysis further include calculating an internal search engine optimization score based on the analysis and the recursive analysis. In one or more embodiments, the internal search engine optimization score includes a domain score and a plurality of page scores associated with at least one of the starting web resource and referred web resources.

The steps of the computer-readable medium encoded with computer-readable instructions for providing search engine optimization analysis further include calculating an external search engine optimization score based on the link index.

The steps of the computer-readable medium encoded with computer-readable instructions for providing search engine optimization analysis further include providing a graphical report. The graphical report includes a visualization of statistical information related to search engine optimization. In one or more embodiments, a user may filter, click, and modify the graphical report to modify viewable search engine optimization analysis results.

The steps of the computer-readable medium encoded with computer-readable instructions for providing search engine optimization analysis further include providing a domain visualization map. The domain visualization map includes a graphical network representation of statistical information for the starting URL and the referred URLs.

In one or more embodiments, the steps of the computer-readable medium encoded with computer-readable instructions for providing search engine optimization analysis further include obtaining at least one search engine ranking of a web resource for at least one of the potential target terms. The external search engine optimization score may be further based on the at least one search engine ranking.

In one or more embodiments, the steps of the computer-readable medium encoded with computer-readable instructions for providing search engine optimization analysis further include determining a content similarity between the text-based portion of the web resources associated with the starting URL and the referred URLs. The statistical information related to search engine optimization may further include the content similarity. The internal search engine optimization score may be further based on the content similarity.

In one or more embodiments, the steps of the computer-readable medium encoded with computer-readable instructions for providing search engine optimization analysis further include performing load time analysis for the web resources associated with the starting URL and the referred URLs. The statistical information related to search engine optimization may include load time information based on the load time analysis.

In one or more embodiments, the steps of the computer-readable medium encoded with computer-readable instructions for providing search engine optimization analysis further include determining one or more negative search engine optimization factors in web resources associated with the starting URL and the referred URLs. The graphical report may include the one or more negative search engine optimization factors.

In one or more embodiments, the steps of the computer-readable medium encoded with computer-readable instructions for providing search engine optimization analysis further include providing exportable data including analysis data for the starting URL and the referred URLs. The steps of the computer-readable medium encoded with computer-readable instructions for providing search engine optimization analysis may further include providing access to the exportable data through an application programming interface.

In one or more embodiments, the steps of the computer-readable medium encoded with computer-readable instructions for providing search engine optimization analysis further include providing access to control the computer-readable instructions through an application programming interface.

One or more embodiments of the invention enable a computer-readable medium encoded with computer-readable instructions for providing search engine optimization analysis. Execution of the computer-readable instructions by one or more processors causes the one or more processors to carry out steps which include obtaining a starting URL identifying a network location for a starting web resource.

The steps of the computer-readable medium encoded with computer-readable instructions for providing search engine optimization analysis further include analyzing the starting URL. The analysis includes obtaining a text-based portion of the starting web resource with data and metadata, processing the data and the metadata to determine potential target terms, and performing a relevancy test of the text-based portion of the starting web resource based on the potential target terms.

The steps of the computer-readable medium encoded with computer-readable instructions for providing search engine optimization analysis further include determining any referred URLs in the text-based portion of the web resource. The referred URLs each identify a referred web resource sharing a domain with the starting web resource.

The steps of the computer-readable medium encoded with computer-readable instructions for providing search engine optimization analysis further include recursively analyzing the referred URLs. The recursive analysis includes obtaining a text-based portion of a referred web resource associated with a referred URL, processing data and metadata in the text-based portion of the referred web resource to determine potential target terms for each referred web resource, and performing a relevancy test of the text-based portion of each referred web resource based on the potential target terms for each referred web resource. In one or more embodiments, the text-based portion of the web resource includes hypertext markup language (HTML) and/or extensible markup language (XML), and processing the data and metadata includes using a different value to determine relevancy of text of at least one of a title tag, a H1 tag, a H2 tag, a H3 tag, an HTTP header, a URL, an image file name, an image alt tag, a microformat, a metatag, and any other text including untagged text in the web resource.

The steps of the computer-readable medium encoded with computer-readable instructions for providing search engine optimization analysis further include analyzing a link index of a network. The link index includes the starting URL. The analysis of the link index includes determining web resources linking to the web resources associated with the starting URL and the referred URLs.

The steps of the computer-readable medium encoded with computer-readable instructions for providing search engine optimization analysis further include calculating an internal search engine optimization score based on the starting web resource analysis and the recursive referred web resources analysis. In one or more embodiments, the internal search engine optimization score includes a domain score and a plurality of page scores associated with the starting web resource and at least one referred web resource.

The steps of the computer-readable medium encoded with computer-readable instructions for providing search engine optimization analysis further include calculating an external search engine optimization score based on the link index.

The steps of the computer-readable medium encoded with computer-readable instructions for providing search engine optimization analysis further include storing a local site cache. The local site cache includes a cache of the starting web resource and the referred web resources.

The steps of the computer-readable medium encoded with computer-readable instructions for providing search engine optimization analysis further include allowing a user to modify the local site cache.

The steps of the computer-readable medium encoded with computer-readable instructions for providing search engine optimization analysis further include repeating the analysis of the starting URL on the local site cache.

The steps of the computer-readable medium encoded with computer-readable instructions for providing search engine optimization analysis further include calculating an adjusted internal search engine optimization score. In one or more embodiments, the adjusted internal search engine optimization score includes a domain score and a plurality of page scores associated with the starting URL on the local site cache.

In one or more embodiments, the steps of the computer-readable medium encoded with computer-readable instructions for providing search engine optimization analysis further include providing a graphical report including a visualization of statistical information related to search engine optimization based on the starting web resource and the referred web resources. The steps further include providing a domain visualization map including a graphical network representation of statistical information for the starting URL and the referred URLs. The steps further include providing an adjusted graphical report including a visualization of statistical information related to the local site cache after the modification. In one or more embodiments, a user may filter, click, and modify the graphical report to modify viewable search engine optimization analysis results. The steps further include providing an adjusted domain visualization map including a graphical network representation of statistical information for the local site cache after the modification.

In one or more embodiments, the steps of the computer-readable medium encoded with computer-readable instructions for providing search engine optimization analysis further include obtaining at least one search engine ranking of a web resource for at least one of the potential target terms. The external search engine optimization score may be further based on the at least one search engine ranking.

In one or more embodiments, the steps of the computer-readable medium encoded with computer-readable instructions for providing search engine optimization analysis further include determining a content similarity between the text-based portion of the web resources associated with the starting URL and the referred URLs. The statistical information may further include the content similarity, where the internal search engine optimization score is based on the content similarity.

In one or more embodiments, the steps of the computer-readable medium encoded with computer-readable instructions for providing search engine optimization analysis further include performing load time analysis for the web resources associated with the starting URL and the referred URLs. The statistical information may further include load time information based on the load time analysis.

In one or more embodiments, the steps of the computer-readable medium encoded with computer-readable instructions for providing search engine optimization analysis further include determining one or more negative search engine optimization factors between web resources associated with the starting URL and the referred URLs. The graphical report may include the one or more negative search engine optimization factors.

In one or more embodiments, the steps of the computer-readable medium encoded with computer-readable instructions for providing search engine optimization analysis further include providing exportable data including analysis data for the starting URL and the referred URLs. The steps of the computer-readable medium encoded with computer-readable instructions for providing search engine optimization analysis may further include providing access to the exportable data through an application programming interface.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more methods, apparatus and/or systems for providing search engine optimization analysis.

FIG. 2 illustrates a diagram in accordance with systems and methods for providing search engine optimization analysis.

FIG. 3 is a flowchart of an exemplary process for analyzing a web resource in accordance with systems and methods for providing search engine optimization analysis.

FIG. 4 is a flowchart of an exemplary process for providing search engine optimization analysis results in accordance with systems and methods for providing search engine optimization analysis.

FIG. 5 is a flowchart of an exemplary process for using a local site cache with systems and methods for providing search engine optimization analysis.

### DETAILED DESCRIPTION

Systems and methods for providing search engine optimization analysis will now be described. In the following exemplary description numerous specific details are set forth in order to provide a more thorough understanding of embodiments of the systems and methods described. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

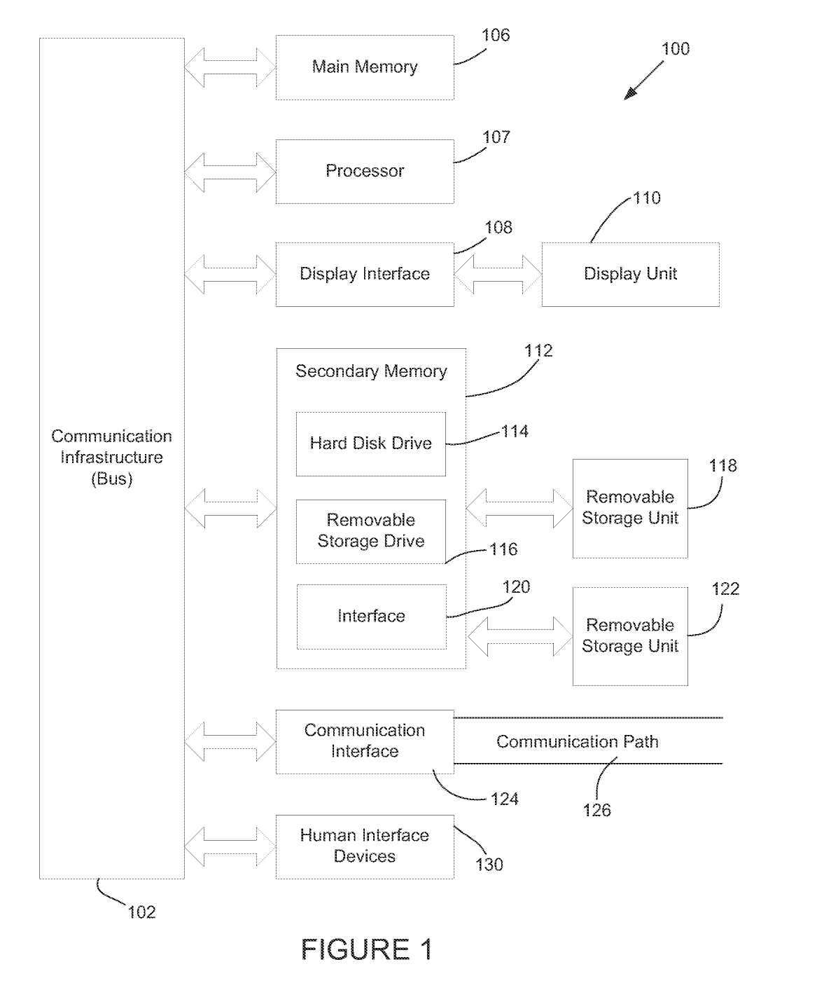

FIG. 1 diagrams a system 100 including a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may include one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may include, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also include interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), wireless networks, optical networks, distributed networks, the Internet or any combination thereof are some examples of the type of communication paths that may be utilized by the specially program computer system. Communication path 126 may include any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may include a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

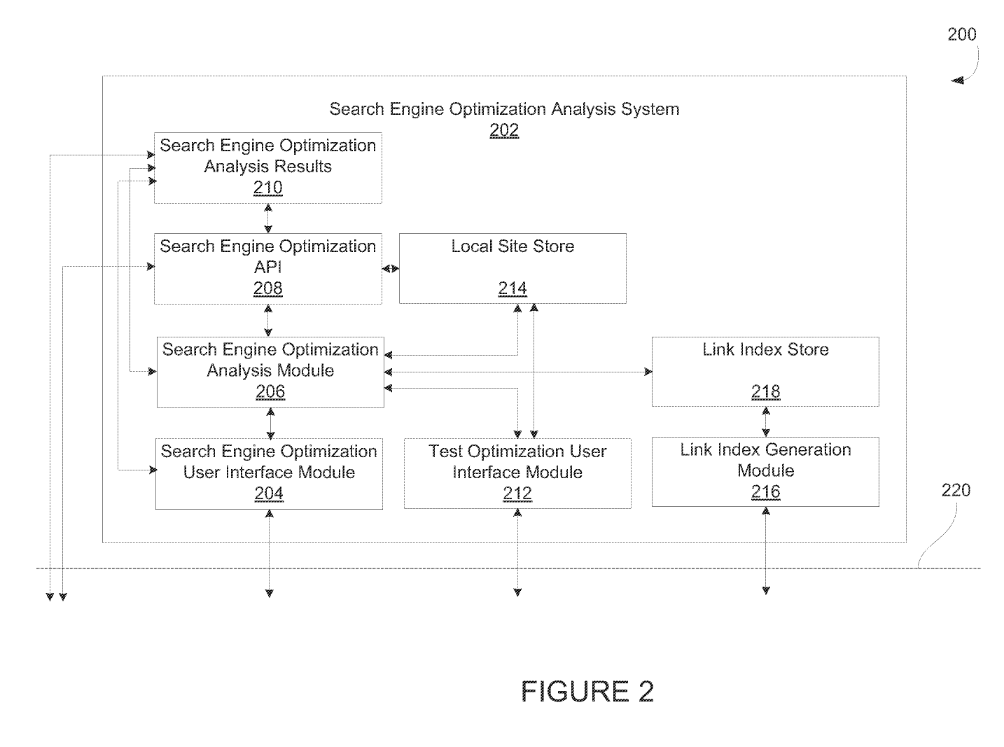

FIG. 2 illustrates a diagram in accordance with systems and methods for providing search engine optimization analysis. System 200 includes search engine optimization analysis system 202. Components of search engine optimization analysis system 202 are configured to communicate over network 220. Network 220 includes at least one telecommunications network, such as Local Area Networks (LAN), Wide Area Networks (WAN), wireless networks, optical networks, distributed networks, the Internet or any combination thereof. In one or more embodiments of search engine optimization analysis system 202, at least a portion of network 220 includes communication path 126.

Components of search engine optimization analysis system 202 are configured to communicate internally within search engine optimization analysis system 202. The components of search engine optimization analysis system 202 may also communicate with each other via network 220. Components of search engine optimization analysis system 202 may also communicate with each other directly through hardware and software within one or more computer systems. In one or more embodiments of search engine optimization analysis system 202, components of search engine optimization analysis system 202 communicate with each other via communication infrastructure 102, such as a system bus. Although bidirectional communication is shown between components of search engine optimization analysis system 202, one of ordinary skill in the art would recognize that at least one communication relationship shown between components of search engine optimization analysis system 202 can be implemented using one-way communication.

Search engine optimization analysis system 202 includes search engine optimization user interface module 204. Search engine optimization user interface module 204 is configurable to provide an interface to a user to perform search engine optimization analysis for one or more starting URLs and to view search engine optimization analysis results 210. In one or more embodiments of search engine optimization analysis system 202, search engine optimization user interface module 204 is configured to provide a user an interface to perform search engine optimization analysis through at least one of a client application executing locally on the user's computer system, one or more web pages, one or more web applications, one or more web services, or any other interface.

Search engine optimization user interface module 204 communicates with search engine optimization analysis module 206 to perform search engine optimization analysis. Search engine optimization analysis module 206 generates search engine optimization analysis results 210, which are made available to search engine optimization user interface module 204, either directly or through search engine optimization analysis module 206.

In one or more embodiments of search engine optimization analysis system 202, search engine optimization user interface module 204 provides a graphical report that includes a visualization of statistical information related to search engine optimization. The graphical report may include one or more displays of statistical data that may be accessed in a hierarchical manner to allow a user to drill down to view detailed statistical information. In one or more embodiments, a user may filter, click, and modify the graphical report to modify viewable search engine optimization analysis results.

In one or more embodiments of search engine optimization analysis system 202, search engine optimization user interface module 204 provides a domain visualization map that includes a graphical network representation of statistical information for the starting URL and referred URLs. The domain visualization map may include an arrangement of multiple URLs within the domain. In one or more embodiments of search engine optimization analysis system 202, the graphical network representation of statistical information is accessible in a hierarchical manner to allow a user to drill down to view detailed statistical information in a graphical network representation.

Search engine optimization analysis system 202 further includes search engine optimization analysis module 206. Search engine optimization analysis module 206 is configured to generate search engine optimization analysis results 210 by analyzing at least one starting uniform resource locator (URL) that identifies the location of a resource on a network, such as a web resource. In one or more embodiments of search engine optimization analysis system 202, the starting URL is a web address.

In one or more embodiments of search engine optimization analysis system 202, search engine optimization analysis module 206 is configured to obtain a text-based portion of a starting web resource identified by the starting URL, where the text-based portion of the starting web resource includes data and metadata. The text-based portion of the starting web resource may include hypertext markup language (HTML) and/or extensible markup language (XML). The text-based portion may include a title tag, and one or more heading tags, such as H1, H2 and H3, an HTTP header, a URL text, an image file name, and image alt tag, a microformat, a metatag, or any other tag. In one or more embodiments of search engine optimization analysis system 202, a different weight value is used to determine the relevancy of text within different portions of the text-based portion as indicated by the HTML tags, XML tags or any other tags. One of ordinary skill in the art would recognize that a different weight or value may be used in the analysis of text in the text-based data when the text is distinguishable as a specific text type, including but not limited to HTML tags and XML tags.

In one or more embodiments, one or more weight values is dynamically modifiable, such as through search engine optimization user interface module 204, search engine optimization API 208, or any other method to allow a user or application to modify one or more weight values used in search engine optimization analysis system 202.

In one or more embodiments of search engine optimization analysis system 202, search engine optimization analysis module 206 is further configured to process the data and metadata to determine a plurality of potential target terms. As used herein, the term “target term” refers to any search term in a query to a search engine, where the search engine returns a plurality of web resources presented in a ranked order. For example, the search engine may return a plurality of web resources presented in a ranked order based on relevance to a search term.

In one or more embodiments of search engine optimization analysis system 202, the at least one potential target terms is further analyzed to determine at least one target term combination. The selection of potential target terms and target term combinations may be further refined by user input. The user input may include business input indicating marketing decisions made to tailor search engine optimization to the refined potential target terms or target term combinations. Search engine optimization analysis module is further configured to perform a relevancy test of the text-based portion of the starting web resource based on the potential target terms.

In one or more embodiments of search engine optimization analysis system 202, search engine optimization analysis module 206 is further configured to determine any referred URLs in the text-based portion of the starting web resource, where each referred URL identifies a referred web resource sharing a domain with the starting web resource. The domain may be identified by analyzing the starting URL. In one or more embodiments of search engine optimization analysis system 202, a user may specify one or more domains which are treated as the domain to be analyzed. In this case, web resources within the one or more domains are recursively analyzed. In one or more embodiments of search engine optimization analysis system 202, URLs that identify external web resources outside of the domain are not recursively analyzed, although data related to external an external web resource may be used in the search engine optimization analysis.

In one or more embodiments of search engine optimization analysis system 202, search engine optimization analysis module 206 is further configured to recursively analyze the referred URLs, where the recursive analysis includes obtaining a text-based portion of a reserved web resource, processing data and metadata in the text-based portion of the referred web resource to determine a plurality of target terms for each referred web resource, and performing a relevancy test of the text-based portion of the referred web resource based on the potential target terms.

In one or more embodiments of search engine optimization analysis system 202, search engine optimization analysis module 206 is further configured to calculate an internal search engine optimization score based on the analysis of the starting URL and the recursive analysis of referred URLs.

In one or more embodiments of search engine optimization analysis system 202, search engine optimization analysis module 206 is further configured to determine the content similarity between web resources associated with the starting URL and the referred URLs. The content similarity may be used to calculate the internal search engine optimization score. In one or more embodiments of search engine optimization analysis system 202, the search engine optimization analysis results 210 generated by search engine optimization analysis module 206 includes statistical information on content similarity.

In one or more embodiments of search engine optimization analysis system 202, search engine optimization analysis module 206 is further configured to perform load time analysis for web resources within the domain. For example, load time analysis may be performed for the starting URL and each referred URL as search engine optimization analysis module 206 recursively analyzes each web resource identified by the starting URL and the referred URLs.

In one or more embodiments of search engine optimization analysis system 202, search engine optimization analysis module 206 is further configured to determine one or more negative search engine optimization factors within the domain. Negative search engine optimization factors may include one or more negative factors selected from the exemplary, non-limiting list in Table 1. For example, negative factors may be detected as search engine optimization analysis module 206 determines referred URLs in each URL analyzed. In addition to web resource information that may be traversed from an initial starting URL, one or more negative search engine optimization factors may also be detected using additional domain information supplied by a user. For example, additional domain information may be used to determine whether any web resources contain one or more negative search engine optimization factors.

In one or more embodiments of search engine optimization analysis system 202, search engine optimization module 206 is further configured to analyze a link index of a network, such as the Internet or any other network containing web resources. The link index of the network includes the starting URL. For example, search engine optimization module 206 may access link index stored 218 to analyze a link index generated and maintained by link index generation module 216. The link index may be analyzed to determine external web resources linking to web resources associated with the starting URL and the referred URLs.

In one or more embodiments of search engine optimization analysis system 202, search engine optimization module 206 is further configured to calculate an external search engine optimization score based on the link index.

In one or more embodiments of search engine optimization analysis system 202, search engine optimization module 206 is further configured to obtain at least one search engine ranking of at least one of the starting URL the referred URLs. The search engine ranking is obtained for at least one of the potential target terms. The search engine ranking for a URL may be obtained from an external search engine, such as Google™, Yahoo!™, Microsoft Bing™, or any other search engine. At least one of the potential target terms is used as a search term in the search engine to determine the ranking of the starting URL or any referred URL based on the potential target terms used.

Search engine optimization analysis system 202 further includes search engine optimization application programming interface (API) 208. Search engine optimization API 208 provides access to search engine optimization analysis functions performed by search engine optimization analysis module 206. Search engine optimization API 208 may be provided over a network, such as network 220. Search engine optimization API 208 is configured to enable external applications to access search engine optimization functionality, including software of third-party search engine optimization firms. For example, search engine optimization API 208 may provide access to search engine optimization functionality over a network, such as by remote procedure calls, web services, UDP, TCP/IP, TLS/SSL, or any other protocol for communication with application, including an external application, over a network. In one or more embodiments of search engine optimization analysis system 202, search engine optimization API 208 provides one or more external applications access to search engine optimization analysis module 206.

Search engine optimization analysis system 202 further includes search engine optimization analysis results 210. Search engine optimization analysis results 210 are generated by search engine optimization analysis module. Search engine optimization analysis results 210 include the internal search engine optimization score, the external search engine optimization score, and other statistical information related to search engine optimization calculated by search engine optimization analysis module 206. The search engine optimization analysis results 210 may be used to generate graphical reports and graphical network representations of the statistical information of search engine optimization analysis results 210.

The internal search engine optimization score may include a domain score and a plurality of page scores associated with each web resource within the domain. Search engine optimization analysis results 210 may also include statistical information on load time analysis for the web resources associated with the starting URL and the referred URL. Search engine optimization analysis results 210 may also include information on negative search engine optimization factors associated with web resources associated with the starting URL and the referred URLs.

Search engine optimization analysis results 210 may be provided to a user through search engine optimization user interface module 204 and/or search engine optimization API 208. In one or more embodiments of search engine optimization analysis system 202, search engine optimization analysis results 210 are made available over network 220, either directly or via search engine optimization user interface module 204 or search engine optimization API 208. For example, search engine optimization analysis results 210 may be made available over a web page, web service, a file transfer protocol, or any other method for providing information in a usable format. In one or more embodiments of search engine optimization analysis system 202, search engine optimization analysis results 210 are made available in a standard format or a proprietary format compatible with one or more third-party applications.

Search engine optimization analysis system 202 further includes local site store 214. Local site store 214 is configured to store at least one local site cache in at least one computer memory medium. The local site cache contains a cached copy of one or more web resources, such as the starting web resource associated with the starting URL and the referred web resources associated with the referred URLs. The local site store 214 may be populated with cached domain information by a user through test optimization user interface module 212. The local site store 214 may also be populated by search engine optimization analysis module 206. For example, search engine optimization analysis module 206 may cache a starting web resource and any referred web resources as these web resources are processed during a recursive search engine optimization analysis.

Search engine optimization analysis system 202 further includes test optimization user interface module 212. Test optimization user interface module 212 may provide an interface to a user to modify a local site cache stored in local site store 214. Test optimization user interface module 212 may be provided over a network, such as network 220. The interface may include an interface to a third-party application, including search engine optimization firms. The user may also be provided one or more tools for web development or design. The user may also be provided an interface for downloading local site cache files and uploading modified local site cache files. Test optimization user interface module 212 may also provide an interface to a user to perform a search engine optimization analysis based on the modified local site cache in local site store 214.

In one or more embodiments of search engine optimization system, search engine optimization analysis module 206 is further configured to perform a search engine optimization analysis on the modified local site cache, and calculate an adjusted internal search engine optimization score based on the modified local site cache.

In one or more embodiments of search engine optimization analysis system 202, a user is presented the option of generating cached domain information and storing a local site cache in local site store 214 when the search engine optimization analysis is performed on a starting URL. The user may modify the local site cache and repeat the analysis of the starting URL on the modified local site cache. In one or more embodiments of search engine optimization analysis system 202, a comparison of the original search engine optimization analysis results and the adjusted search engine optimization analysis results are provided. The comparison may include the internal search engine optimization score and the external search engine optimization score as well as any other statistical information related to search engine optimization. In one or more embodiments of search engine optimization analysis system 202, an adjusted graphical report including a visualization of statistical information related to the modified local site cache is provided. Search engine optimization analysis system 202 may also provide adjusted domain visualization map including a graphical network representation of statistical information for the modified local site cache.

In one or more embodiments of search engine optimization analysis system 202, test optimization user interface module 212 is configured to provide a user interface to a user or an external application through one or more web pages, web applications, web services or other Internet-based interface.

Test optimization user interface module 212 and search engine optimization user interface module 204 may provide an interface to a user through a shared user interface or through separate user interfaces of one or more applications.

Search engine optimization analysis system 202 further includes link index generation module 216. Link index generation module 216 generates and maintains an index of a network. In one or more embodiments of search engine optimization system 210, link index generation module 216 generates and maintains a link index of all links between web resources on a network. Link index generation module 216 may be configured to regularly update the link index to accurately reflect the current links between web resources on the network. For example, the link index may be updated periodically, such as daily, weekly, monthly, or any other period suitable for scheduling link index maintenance. In one or more embodiments of search engine optimization analysis system 202, link index generation module 216 generates and maintains an index of the Internet based on web resources that may be accessed by traversing links from one or more initial web resources.

Search engine optimization analysis system 202 further includes link index store 218. Link index store 218 includes link index information stored in at least one computer memory medium. The link index information is generated and maintained by index generation module 216. In one or more embodiments of search engine optimization analysis system 202, link index store 218 contains a link index of the Internet.

In one or more embodiments of search engine optimization analysis system 202, search engine optimization analysis module 206 accesses link index information stored in link index store 218 to perform search engine optimization analysis and to calculate an external search engine optimization score based on the link index information. Search engine optimization and analysis module 206 may be configured to determine web resources linking to a starting URL and referred URLs.

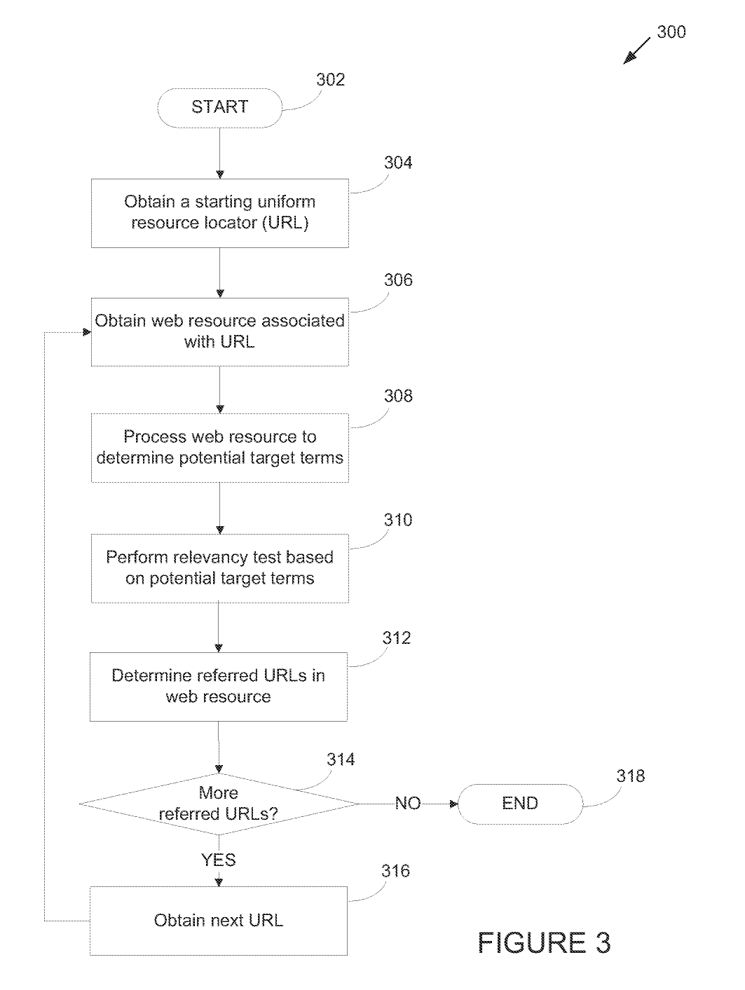

FIG. 3 is a flowchart of an exemplary process for analyzing a web resource in accordance with systems and methods for providing search engine optimization analysis. Process 300 starts at step 302.

Processing continues to step 304, where a starting URL is obtained. The starting URL identifies a network location for a starting web resource. In one and more embodiments of process 300, the starting URL is a web address.

Processing continues to step 306, where at least a portion of a web resource associated with a URL is obtained. In one or more embodiments, a text-based portion of the web resource is obtained. The text-based portion of the web resource includes data and metadata. For example, the text-based portion of the web resource may include HTML and/or XML, such as a title tag, one or more heading tags, an HTTP header, a URL text, an image file name, and image alt tag, a microformat, a metatag, or any other HTML tag or XML tag.

Processing continues to step 308, where the web resource is processed to determine a plurality of potential target terms. In one or more embodiments of process 300, the plurality of potential target terms is further analyzed to determine at least one potential target term combination. The selection of potential target terms and target term combinations may be further refined by user input.

Processing continues to step 310, where a relevancy test is performed based on the potential target terms, including the potential target term combinations.

Processing continues to step 312, where referred URLs contained in the web resource are determined. In one or more embodiments of process 300, a text-based portion of the web resource is analyzed to identify any referred URL in the same domain as the current web resource. Although data related to URLs identifying an external web resource may be used to calculate search engine optimization analysis results, URLs identifying external web resources are not considered referred URLs in process 300. In one or more embodiments of process 300, one or more specified domains are treated as the internal domain, and web resources external to the internal domain are not considered referred URLs.

Processing continues to decision step 314, where it is determined whether or not more referred URLs need to be processed. In one or more embodiments of process 300, all referred URLs are recursively analyzed until all referred URLs identified are processed. If it is determined that any referrer URL has not been processed, processing continues to step 316, where the next URL to process is obtained. Processing continues to step 306, where the next URL obtained is recursively analyzed.

Returning to decision step 314, if it is determined that no more referred URLs need to be processed, processing continues to step 318. At step 318, process 300 terminates.

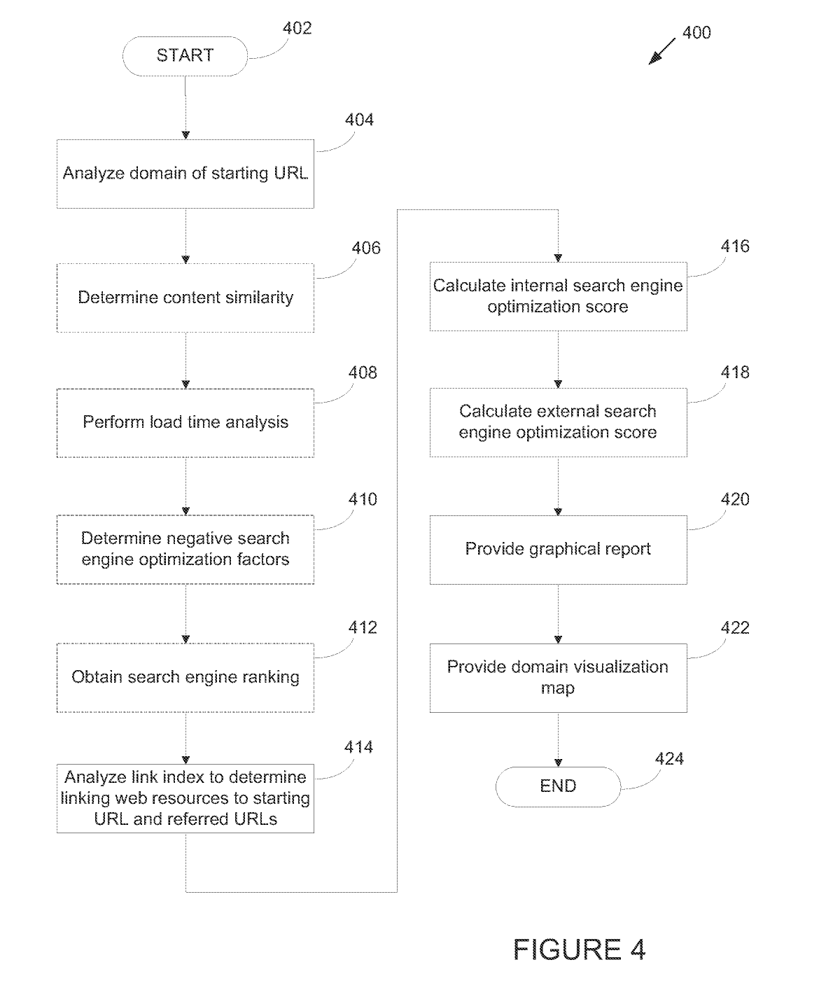

FIG. 4 is a flowchart of an exemplary process for providing search engine optimization analysis results in accordance with systems and methods for providing search engine optimization analysis. Process 400 begins at step 402.

Processing continues to step 404, where a domain of a starting URL is analyzed. For example, the domain of the starting URL may be analyzed using a recursive process for analyzing a starting URL and referred URLs within the domain, as described in process 300. In one or more embodiments of process 400, the domain analyzed may include one or more specified domains. The domain may also be determined based on the domain of the starting URL.

Processing continues to optional step 406, where the constant similarity between web resources associated with the starting URL and referred URLs is determined. The constant similarity may be used to calculate search engine optimization analysis results, including statistical information on content similarity. In one or more embodiments of process 400, content similarity is alternatively performed during the recursive analysis of web resources in the domain that are reachable by traversing referred URLs from the starting URL in step 404.

Processing continues to optional step 408, where load time analysis is performed for web resources within the domain. The load time analysis may be used to calculate search engine optimization analysis results, including statistical information on load time analysis. In one or more embodiments of process 400, load time analysis is alternatively performed during the recursive analysis of web resources in the domain that are reachable by traversing referred URLs from the starting URL in step 404.

Processing continues to optional step 410, where one or more negative search engine optimization factors are determined. Negative search engine optimization factors may include one or more negative factors selected from the exemplary, non-limiting list in Table 1. Negative search engine optimization factors may be used to calculate search engine optimization analysis results, including statistical information on one or more negative search engine optimization factors. In one or more embodiments of process 400, negative search engine optimization factor detection is alternatively performed during the analysis of the domain of the starting URL at step 404.

Processing continues to optional step 412, where at least one search engine ranking of at least one of the starting URL and the referred URLs is obtained. The search engine ranking is obtained for at least one of the potential target terms identified during the analysis of the domain of the starting URL in step 404. The search engine ranking for a URL may be obtained from an external search engine, such as Google™, Yahoo!™, Microsoft Bing™, or any other search engine. In one or more embodiments, the search engine ranking is a Google™ PageRank™. At least one of the potential target terms is used as a search term in the search engine to determine the search engine ranking of the URL based on the potential target terms used.

Processing continues to step 414, where a link index is analyzed to determine linking web resources to the starting URL and any referred URLs within the domain. In one or more embodiments of process 400, the link index includes an index of all links between web resources on a network, such as the Internet. The link index may be periodically maintained to accurately reflect the current links between web resources on the network.

Processing continues to step 416, where an internal search engine optimization score is calculated. The internal search engine optimization score is based on at least one of the analysis of the domain of the starting URL, the content similarity, load time analysis, negative search engine optimization factors, and search engine ranking. In one or more embodiments, the internal search engine optimization score includes a domain score and a plurality of page scores associated with the starting web resource and at least one referred web resource.

Processing continues to step 418, where an external search engine optimization score is calculated. The external search engine optimization score is based on at least one of analyzing the link index and search engine ranking.

Processing continues to step 420, where a graphical report is provided. The graphical report includes a visualization of statistical information related to search engine optimization. For example, the graphical report may include a visualization of search term analysis, content similarity, load time analysis, negative search engine optimization factors, search engine ranking, external linking web resources, external search engine optimization scores, and internal search engine optimization scores, including domain scores and individual page scores. The graphical report may include one or more displays of statistical data that may be accessed in a hierarchical manner to allow a user to drill down to view detailed statistical information. In one or more embodiments, a user may filter, click, and modify the graphical report to modify viewable search engine optimization analysis results.

Processing continues to step 422, where a domain visualization map is provided. The domain visualization map includes a graphical network representation of statistical information for the starting URL and referred URLs. For example, the graphical network representation of statistical information may illustrate network relationships showing statistical information regarding search term analysis, content similarity, load time analysis, negative search engine optimization factors, search engine ranking, external linking web resources, and any other information presentable as network relationships between web resources within a domain. The domain visualization map may include an arrangement of multiple URLs within the domain. In one or more embodiments of process 400, the graphical network representation of statistical information is accessible in a hierarchical manner to allow a user to drill down to view detailed statistical information in a graphical network representation.

Processing continues to step 424, where process 400 terminates.

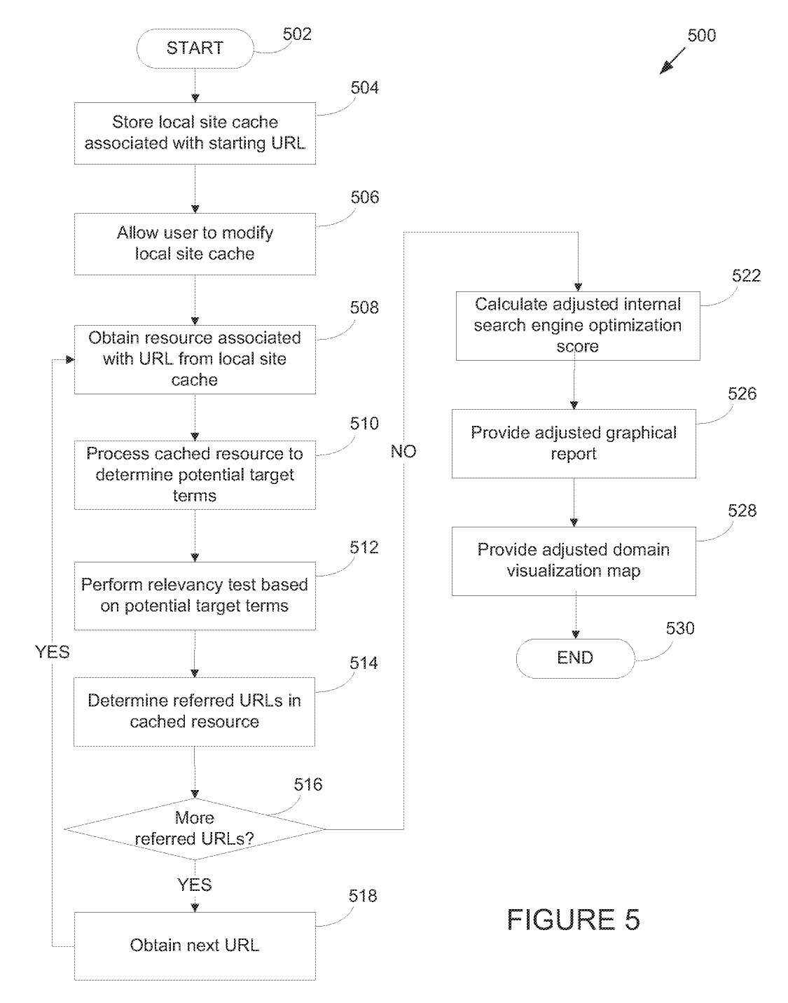

FIG. 5 is a flowchart of an exemplary process for using a local site cache with systems and methods for providing search engine optimization analysis. Process 500 starts at step 502.

Processing continues to step 504, where a local site cache associated with the starting URL is stored. The local domain contains a cached copy of one or more web resources from a domain, such as one or more specified domains, or a domain to which a starting web resource belongs. The local site cache may be populated by copying domain location specified by a user, a configuration file, or by any other method. The local site cache may also be created in the process of recursively analyzing web resources in a domain that are reachable from the starting URL.

Processing continues to step 506, when a user is allowed to modify web resources stored in the local site cache. For example, a user may be allowed to modify web resources through an interface. For example, the interface may include an interface to a third-party application for web development or design including third-party search engine optimization software, one or more tools for web development or design, and interface for downloading local site cache files and uploading modified local site cache files after modification, or any other method for allowing a user to modify web resources stored in the local site cache.

Processing continues to step 508, where a cached resource associated with a URL from the local site cache is obtained from the modified local site cache. In one or more embodiments, a text-based portion of the cached resource is obtained. The text-based portion of the cached resource includes data and metadata. For example, the text-based portion of the cached resource may include HTML and/or XML, such as a title tag, one or more heading tags, an HTTP header, a URL text, an image file name, and image alt tag, a microformat, a metatag, or any other HTML tag or XML tag.

Processing continues to step 510, where the cached resource is process to determine potential target terms. The potential target terms may be further analyzed to determine at least one potential target term combination, where the potential target term combination is a combination of potential target terms.

Processing continues to step 512, where a relevancy test is performed based on the potential target terms, including the potential target term combinations.

Processing continues to step 514, where referred URLs contained in the cached resource are determined. In one or more embodiments of process 500, a text-based portion of the cached resource is analyzed to identify any URL in the domain stored in the local site cache. Although URLs identifying an external resource may be used to calculate search engine optimization analysis results, URLs identifying external resources are not considered referred URLs in process 500. In one or more embodiments of process 500, one or more specified domains are treated as the internal domain, and resources external to the one or more specified domains are not considered referred URLs.

Processing continues to decision step 516, where it is determined whether or not more referred URLs need to be processed. In one or more embodiments of process 500, all referred URLs are recursively analyzed until all referred URLs identified are processed. If it is determined that any referrer URL has not been processed, processing continues to step 518, where the next URL to process is obtained. Processing continues to step 518, where the next URL obtained is recursively analyzed.

Returning to decision step 516, when it is determined that no more referred URLs need to be processed, processing continues to step 520.

Processing continues to step 522, where an adjusted internal search engine optimization score is calculated. The internal search engine optimization score is based on the analysis of the local site cache. In one or more embodiments of process 500, the internal search engine optimization score is also based on at least one of content similarity, load time analysis, negative search engine optimization factors, and search engine ranking. In one or more embodiments of process 500, the internal search engine optimization score includes a domain score and a plurality of page scores associated with the starting URL and at least one referred URL.

Processing continues to step 526, where an adjusted graphical report is provided. The adjusted graphical report includes a visualization of statistical information related to search engine optimization with respect to the modified local site cache. For example, the adjusted graphical report may include a visualization of search term analysis, content similarity, load time analysis, negative search engine optimization factors, search engine ranking, external linking web resources, external search engine optimization scores, and internal search engine optimization scores, including domain scores and individual page scores. The adjusted graphical report may include one or more displays of statistical data that may be accessed in a hierarchical manner to allow a user to drill down to view detailed statistical information. In one or more embodiments, a user may filter, click, and modify the graphical report and/or the adjusted graphical report to modify viewable search engine optimization analysis results.

In one or more embodiments, the adjusted graphical report also provides a comparison with an original search engine optimization result for an original search engine optimization analysis of web resources in a domain based on the starting URL.

Processing continues to step 528, where an adjusted domain visualization map is provided. The domain visualization map includes a graphical network representation of statistical information for the modified local site cache. For example, the graphical network representation of statistical information may illustrate network relationships showing statistical information regarding search term analysis, content similarity, load time analysis, negative search engine optimization factors, search engine ranking, external linking web resources, and any other information presentable as network relationships between web resources within a domain. The domain visualization map may include an arrangement of multiple URLs within the domain. In one or more embodiments of process 500, the graphical network representation of statistical information is accessible in a hierarchical manner to allow a user to drill down to view detailed statistical information in a graphical network representation.

In one or more embodiments, the adjusted domain visualization map also provides a comparison with an original search engine optimization result for an original search engine optimization analysis of web resources in a domain based on the starting URL.

Processing continues to 530, where process 500 terminates.

While the invention herein disclosed has been described by means of specific embodiments and applications thereof, numerous modifications and variations could be made thereto by those skilled in the art without departing from the scope of the invention set forth in the claims.

TABLE 1
Negative search engine optimization factors

| Negative search engine | |
|---|---|
| optimization factors | Additional Notes |
| Domain linking errors | |
| Cloaking | |
| Comment spam | e.g. comments from forums, wikis, blogs, |
| | or any other user-generated comment |
| Links to or from bad | |
| neighborhoods | |
| Reciprocal linking | |
| No-Follow links | |
| Insufficient content | |
| Soft 404 errors | Page returns partial information |
| Auto generated content | |
| Spider Traps | |
| Hacked pages | e.g. malware, phishing, etc. |
| Keyword stuffing | |
| Broken Redirects | |
| 302 Redirects | |
| Hidden text | e.g. CSS, JavaScript, HTML tags, |
| | NoScript, etc. |
| Javascript links/redirects | |
| Duplicate content | |
| Chaining redirects | |
| Flash sites/navigation | |
| AJAX | |
| No consistent URL structure | |
| Excessive parameters | |
| Too many directories | |
| Inconsistent URL structure | |
| Subdomains | |
| Meta Refresh Redirects | |
| Excluded URLS | e.g. Robots.txt, noindex, nofollow |

What is claimed is:

1. A computer-readable medium comprising computer-readable instructions for providing search engine optimization analysis, wherein execution of said computer-readable instructions by one or more processors causes said one or more processors to carry out steps comprising:
obtaining a starting uniform resource locator identifying a network location for a starting web resource;
analyzing said starting uniform resource locator, wherein said analyzing comprises obtaining a text-based portion of said starting web resource comprising data and metadata, processing said data and said metadata to determine a plurality of potential target terms, and performing a relevancy test of said text-based portion of said starting web resource based on said plurality of potential target terms;
determining any referred uniform resource locators in said text-based portion of said starting web resource, wherein said referred uniform resource locators each identify a referred web resource sharing a domain with said starting web resource;
recursively analyzing said referred uniform resource locators, said recursive analysis comprising obtaining an additional text-based portion of a referred web resource; processing additional data and additional metadata in said additional text-based portion of said referred web resource to determine additional potential target terms for each referred web resource, and performing an additional relevancy test of said additional text-based portion of each referred web resource based on said additional potential target terms for each referred web resource;
analyzing a link index of a network comprising said starting uniform resource locator to determine web resources linking to said web resources associated with said starting uniform resource locator and said referred uniform resource locators;
calculating an internal search engine optimization score based on said analysis and said recursive analysis;
calculating an external search engine optimization score based on said link index;
providing a graphical report comprising a visualization of statistical information related to search engine optimization; and
providing a domain visualization map comprising a graphical network representation of said statistical information for said starting uniform resource locator and said referred uniform resource locators.

2. The computer-readable medium of claim 1, wherein said text-based portion of said web resource comprises hypertext markup language (HTML) and wherein said processing said data and metadata comprises using at least one weight value to determine relevancy of text of at least one of a title tag, a H1 tag, a H2 tag, a H3 tag, an HTTP header, a uniform resource locator, an image file name, an image alt tag, a microformat, and a metatag.

3. The computer-readable medium of claim 1, wherein said computer-readable instructions further comprise obtaining at least one search engine ranking of at least one of said starting uniform resource locator and said referred uniform resource locators for at least one of said plurality of potential target terms, wherein said external search engine optimization score is further based on said at least one search engine ranking.

4. The computer-readable medium of claim 1, wherein said computer-readable instructions further comprise determining a content similarity between said text-based portion of said web resources associated with said starting uniform resource locator and said referred uniform resource locators, and
wherein said statistical information comprises said content similarity and wherein said internal search engine optimization score is based on said content similarity.

5. The computer-readable medium of claim 1, wherein said internal search engine optimization score comprises a domain score and a plurality of page scores associated with at least one of said starting web resource and said at least one referred web resource.

6. The computer-readable medium of claim 1, wherein said computer-readable instructions further comprise performing load time analysis for said web resources associated with said starting uniform resource locator and said referred uniform resource locators, and
wherein said statistical information comprises load time information based on said load time analysis.

7. The computer-readable medium of claim 1, wherein said computer-readable instructions further comprise determining one or more negative search engine optimization factors associated with web resources associated with said starting uniform resource locator and said referred uniform resource locators, and
wherein said graphical report comprises one or more negative search engine optimization factors.

8. The computer-readable medium of claim 1, wherein said computer-readable instructions further comprise providing exportable data comprising analysis data for said starting uniform resource locator and said referred uniform resource locators.

9. The computer-readable medium of claim 7, wherein said computer-readable instructions further comprise providing access to said exportable data through an application programming interface.

10. The computer-readable medium of claim 1, wherein said computer-readable instructions further comprise providing access to control said computer-readable instructions through an application programming interface.

11. A computer-readable medium comprising computer-readable instructions for providing search engine optimization analysis, wherein execution of said computer-readable instructions by one or more processors causes said one or more processors to carry out steps comprising:
obtaining a starting uniform resource locator identifying a network location for a starting web resource;
analyzing said starting uniform resource locator, wherein said analyzing comprises obtaining a text-based portion of said starting web resource comprising data and metadata, processing said data and said metadata to determine a plurality of potential target terms, and performing a relevancy test of said text-based portion of said starting web resource based on said plurality of potential target terms;
determining any referred uniform resource locators in said text-based portion of said starting web resource, wherein said referred uniform resource locators each identify a referred web resource sharing a domain with said starting web resource;
recursively analyzing said referred uniform resource locators, said recursive analysis comprising obtaining an additional text-based portion of a referred web resource; processing additional data and additional metadata in said additional text-based portion of said referred web resource to determine additional potential target terms for each referred web resource, and performing an additional relevancy test of said additional text-based portion of each referred web resource based on said additional potential target terms for each referred web resource;
analyzing a link index of a network comprising said starting uniform resource locator to determine web resources linking to said web resources associated with said starting uniform resource locator and said referred uniform resource locators;
calculating an internal search engine optimization score based on said analysis and said recursive analysis;
calculating an external search engine optimization score based on said link index;
storing a local site cache comprising said starting web resource and said referred web resources;
allowing a user to modify said local site cache;
repeating said analysis of said starting uniform resource locator on said modified local site cache, including said recursive analysis; and
calculating an adjusted internal search engine optimization score.

12. The computer-readable medium of claim 11, wherein said computer-readable instructions further comprise:
providing a graphical report comprising a visualization of statistical information related to search engine optimization based on said starting web resource and said referred web resources;
providing a domain visualization map comprising a graphical network representation of said statistical information for said starting uniform resource locator and said referred uniform resource locators;
providing an adjusted graphical report comprising an adjusted visualization of adjusted statistical information related to said local site cache after said modification; and
providing an adjusted domain visualization map comprising an adjusted graphical network representation of said adjusted statistical information for said local site cache after said modification.

13. The computer-readable medium of claim 11, wherein said text-based portion of said web resource comprises hypertext markup language (HTML) and wherein said processing said data and metadata comprises using at least one weight value to determine relevancy of text of at least one of a title tag, a H1 tag, a H2 tag, a H3 tag, an HTTP header, a uniform resource locator, an image file name, an image alt tag, a microformat, and a metatag.

14. The computer-readable medium of claim 11, wherein said computer-readable instructions further comprise obtaining at least one search engine ranking of at least one of said starting uniform resource locator and said referred uniform resource locators for at least one of said plurality of potential target terms, wherein said external search engine optimization score is further based on said at least one search engine ranking.

15. The computer-readable medium of claim 11, wherein said computer-readable instructions further comprise determining a content similarity between said text-based portion of said web resources associated with said starting uniform resource locator and said referred uniform resource locators, and
wherein said statistical information comprises said content similarity and wherein said internal search engine optimization score is based on said content similarity.

16. The computer-readable medium of claim 11, wherein said internal search engine optimization score comprises a domain score and a plurality of page scores associated with said starting web resource and at least one referred web resource.

17. The computer-readable medium of claim 11, wherein said computer-readable instructions further comprise performing load time analysis for said web resources associated with said starting uniform resource locator and said referred uniform resource locators, and
wherein said statistical information comprises load time information based on said load time analysis.

18. The computer-readable medium of claim 11, wherein said computer-readable instructions further comprise determining one or more negative search engine optimization factors associated with web resources associated with said starting uniform resource locator and said referred uniform resource locators, and
wherein said graphical report comprises said one or more negative search engine optimization factors.

19. The computer-readable medium of claim 11, wherein said computer-readable instructions further comprise providing exportable data comprising analysis data for said starting uniform resource locator and said referred uniform resource locators.

20. The computer-readable medium of claim 19, wherein said computer-readable instructions further comprise providing access to said exportable data through an application programming interface.

21. The computer-readable medium of claim 1, wherein said computer-readable instructions further comprise allowing a user to dynamically modify one or more of said at least one weight value.
